(19) United States
(12) Patent Application Publication
(10) Pub. No.: US 2025/0095118 A1
(43) Pub. Date: Mar. 20, 2025

(54) NOISE REDUCTION APPARATUS, NOISE REDUCTION METHOD AND COMPUTER PROGRAM

(71) Applicant: NIPPON TELEGRAPH AND TELEPHONE CORPORATION, Tokyo (JP)

(72) Inventors: Yoko SOGABE, Musashino-shi, Tokyo (JP); Shiori SUGIMOTO, Musashino-shi, Tokyo (JP); Masaki KITAHARA, Musashino-shi, Tokyo (JP); Tokinobu MITASAKI, Musashino-shi, Tokyo (JP)

(73) Assignee: NIPPON TELEGRAPH AND TELEPHONE CORPORATION, Tokyo (JP)

(21) Appl. No.: 18/726,052

(22) PCT Filed: Jan. 12, 2022
(86) PCT No.: PCT/JP2022/000773

§ 371 Date: Jul. 1, 2024

(51) Int. Cl. G06T 5/70; G06V 10/74

(52) U.S. Cl. CPC G06T 5/70; G06V 10/761; G06T 2207/20182

(57) ABSTRACT

According to an aspect of the present invention, there is provided a noise reducing device including: a provisional image reconstructing unit that generates a provisional image by reconstructing an encoded image obtained through compressed spectral imaging; a similar patch search unit that acquires a plurality of similar provisional patches that are small regions including images similar to each other in the provisional image; a group generating unit that acquires a plurality of similar encoded patches that are small regions including images similar to each other in the encoded image based on information on positions where the similar provisional patches have been acquired; a low-rank approximation unit that performs low-rank approximation based on the plurality of similar encoded patches to acquire a patch in which noise on an image has been reduced in a region included in the similar encoded patches; and a patch integrating unit that generates an encoded image by integrating a plurality of patches in which noise has been reduced, depending on information on positions of the patches.

### TECHNICAL FIELD

The present invention relates to technologies of a noise reducing device, a method for reducing noise, and a computer program.

### BACKGROUND ART

A general spectral image acquiring device obtains one spectral image by capturing images many times while mechanically driving a slit using a complicated imaging device including the slit and a dispersive element. Therefore, it is difficult to capture a moving image that requires tens of images per second. On the other hand, compressed spectral imaging is a technology that enables spectral images to be acquired at a frame rate of a moving image level by using a compressed sensing theory. The compressed sensing is a sensing theory that enables a signal of a sensing target to be acquired with a number of samples smaller than that provided by a sampling theorem, by using a statistical property (redundancy) of the signal of the sensing target. In the compressed spectral imaging, a spectral image is optically encoded, and an encoded image in a color image or monochrome image format is acquired by a camera. Accordingly, spectral information is estimated from the encoded image by using an image reconstruction technology, and a spectral image is obtained.

An encoded image in the compressed spectral imaging may include noise called thermal noise or shot noise as in general image capturing. A short exposure time to realize a high frame rate results in a relatively large amount of noise. When a spectral image is reconstructed from an encoded image including a large amount of noise, reconstruction of fine features may fail or an artifact (significant distortion produced in a process of reconstruction) may occur.

### CITATION LIST

### Non Patent Literature

Non Patent Literature 1: Shuhang Gu, Lei Zhang, Wangmeng Zuo, and Xiangchu Feng. “Weighted nuclear norm minimization with application to image denoising,” In Proceedings of the IEEE conference on computer vision and pattern recognition, pp. 2862-2869, 2014.

### SUMMARY OF INVENTION

### Technical Problem

In order to solve the problems described above, it is conceivable to execute a noise reducing process on an encoded image. However, if a method for reducing noise for a color or monochrome image/moving image is applied as it is, the method does not function effectively since properties of a general image and an encoded image are significantly different from each other. How the properties of the encoded image are different from those of a general monochrome image and color image depends on a method of compressed spectral imaging.

For example, in a technology called CASSI, coded apertures are used in an imaging device. In the technology, an aperture pattern on a mosaic may be observed in an encoded image in a form of superimposing an object that is an imaging target. In addition, a wavelength-dependent PSF technology has properties significantly different from those of a general image in that an image may be significantly blurred or multiplexed. Thus, the encoded image has properties significantly different from those of a general image. Further, the properties of the encoded image vary significantly depending on a type of compressed spectral imaging. Therefore, it has been difficult to appropriately reduce noise.

In view of the aforementioned circumstances, an object of the present invention is to provide a technology capable of reducing noise in an encoded image obtained by compressed spectral imaging.

### Solution to Problem

According to an aspect of the present invention, there is provided a noise reducing device including: a provisional image reconstructing unit that generates a provisional image by reconstructing an encoded image obtained through compressed spectral imaging; a similar patch search unit that acquires a plurality of similar provisional patches that are small regions including images similar to each other in the provisional image; a group generating unit that acquires a plurality of similar encoded patches that are small regions including images similar to each other in the encoded image based on information on positions where the similar provisional patches have been acquired; a low-rank approximation unit that performs low-rank approximation based on the plurality of similar encoded patches to acquire a patch in which noise on an image has been reduced in a region included in the similar encoded patches; and a patch integrating unit that generates an encoded image by integrating a plurality of patches in which noise has been reduced, depending on information on positions of the patches.

According to another aspect of the present invention, there is provided a method for reducing noise, the method including: a provisional image reconstructing step of generating a provisional image by reconstructing an encoded image obtained through compressed spectral imaging; a similar patch searching step of acquiring a plurality of similar provisional patches that are small regions including images similar to each other in the provisional image; a group generating step of acquiring a plurality of similar encoded patches that are small regions including images similar to each other in the encoded image based on information on positions where the similar provisional patches have been acquired; a low-rank approximation step of performing low-rank approximation based on the plurality of similar encoded patches to acquire a patch in which noise on an image has been reduced in a region included in the similar encoded patches; and a patch integrating step of generating an encoded image by integrating a plurality of patches in which noise has been reduced, depending on information on positions of the patches.

According to still another aspect of the present invention, there is provided a computer program for causing a computer to function as the aforementioned noise reducing device.

### Advantageous Effects of Invention

According to the present invention, noise of an encoded image obtained through compressed spectral imaging can be reduced.

### BRIEF DESCRIPTION OF DRAWINGS

FIG. 1 is a diagram schematically illustrating a technology of the present invention.

FIG. 2 is a diagram illustrating a configuration example of a spectral image generating device 100 of the present invention.

FIG. 3 is a diagram illustrating a first embodiment of a noise reducing unit 21.

FIG. 4 is a flowchart illustrating a specific example of a processing flow of the spectral image generating device 100 including the noise reducing unit 21 of the first embodiment.

FIG. 5 is a diagram illustrating a second embodiment (noise reducing unit 21a) of the noise reducing unit 21.

FIG. 6 is a flowchart illustrating a specific example of a processing flow of a spectral image generating device 100 including the noise reducing unit 21a of the second embodiment.

### DESCRIPTION OF EMBODIMENTS

### [Outline]

Embodiments of the present invention will be described in detail with reference to the drawings. First, outlines of the embodiments of the present invention will be described. In the following description, characters written using “_” in a sentence indicate subscripts, as follows. For example, a sign “M_i” indicates that “i” should be attached as a subscript at the lower right of “M”. For example, a sign “M_(i+1)” indicates that “i+1” should be attached as a subscript at the lower right of “M”. In the following description, characters written using “\hat{ }” in a sentence indicate characters having “\hat{ }” attached above the characters, as follows. For example, a sign “M\hat{ }” indicates that “\hat{ }” should be attached above “M”. In the following description, characters written using “-” in a sentence indicate superscripts, as follows. For example, a sign “M-i” indicates that “i” should be attached as a superscript at the upper right of “M”. For example, a sign “M-(i+1)” indicates that “i+1” should be attached as a superscript at the upper right of “M”.

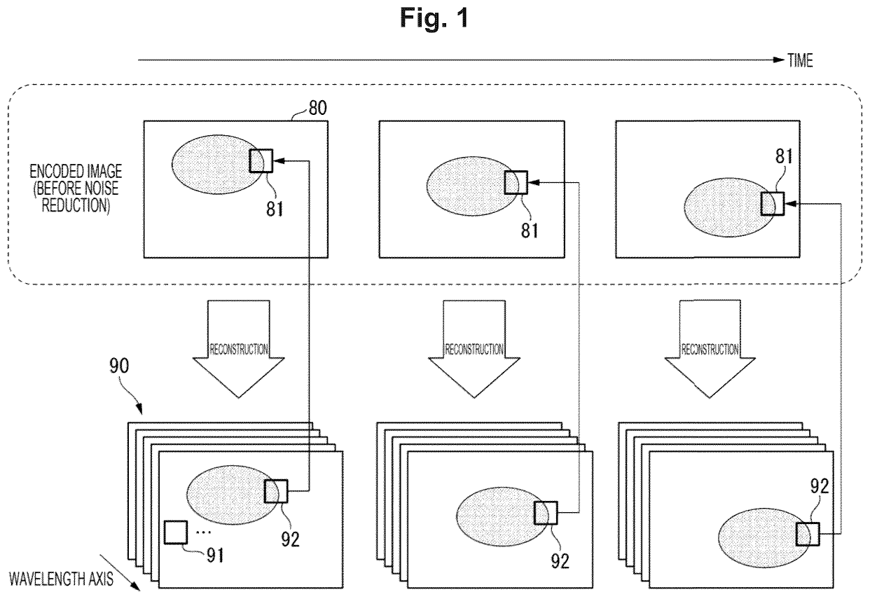

FIG. 1 is a diagram schematically illustrating a technology of the present invention. In the present embodiment, there is provided a method for reducing noise for an encoded image of compressed spectral imaging using a low-rank matrix reconstruction method based on weighted nuclear norm minimization. In a low-rank matrix reconstruction method based on nuclear norm minimization (see Non Patent Literature 1), an image is spatially divided into a plurality of small regions (hereinafter, referred to as “patches”) having a predetermined spatial size. Accordingly, it is necessary to acquire patches (hereinafter, referred to as “similar patches”) including a similar image pattern from the same frame or different frames. On the other hand, an encoded image of compressed spectral imaging is an optically encoded special image. Therefore, it is not possible to accurately acquire similar patches by a technology such as block matching that is generally used.

In this respect, in the present embodiment, first, in an encoded image 80 before a noise reduction is performed, a spectral image is provisionally reconstructed for searching for similar patches. Accordingly, a plurality of patches 91 (hereinafter, referred to as “provisional patches”) are generated using a provisionally reconstructed spectral image (hereinafter, referred to as a “provisional image”) 90, and positions of similar provisional patches 92 similar to each other are obtained from the provisional patches 91. The similar provisional patches 92 may be searched for in the same provisional image or may be searched for in another provisional image obtained at a different time. In the present embodiment, searching is performed in both provisional images. In the example of FIG. 1, the similar provisional patches 92 are searched for in the provisional images at three different times. A position of each similar provisional patch 92 is represented using spatial information (for example, information on the position represented by spatial coordinates in the image) and temporal information (for example, information on a time point of imaging or information on numbers of frames arranged in order).

Positions of the patches 81 similar to each other (hereinafter, referred to as “similar encoded patches”) are identified in the encoded image 80 by using the positions of the similar provisional patches 92 obtained using the provisional image 90. A noise reduction is performed on the encoded image by using the similar encoded patches 81. The provisional image 90 has a low quality because the encoded image 80 including noise is used. However, the provisional image 90 can be used to search for the positions of the similar provisional patches 92. Thus, the provisional image 90 is used to collect the similar encoded patches 81 in the encoded image 80, and thereby it is possible to prevent inaccuracy of similar patch collection due to an influence of unique properties of the encoded image.

### [Details]

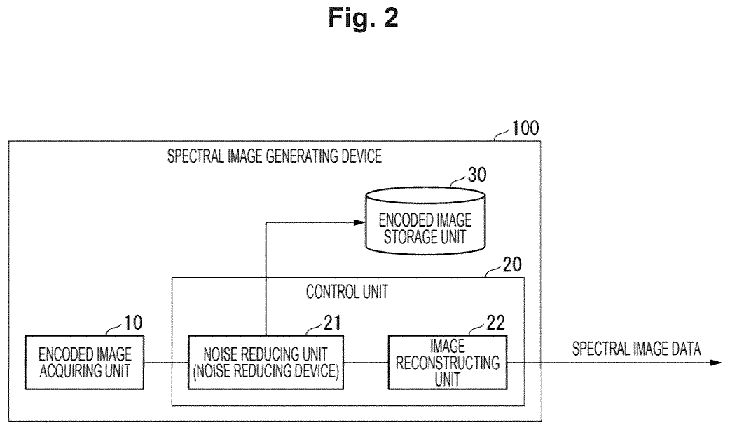

Next, details of the technology of the present invention will be described. FIG. 2 is a diagram illustrating a configuration example of a spectral image generating device 100 of the present invention. The spectral image generating device 100 includes an encoded image acquiring unit 10, a control unit 20, and an encoded image storage unit 30.

The encoded image acquiring unit 10 acquires an encoded spectral image (hereinafter, referred to as an “encoded image”). The encoded image acquiring unit 10 may acquire data of an encoded image captured in advance or may acquire data of an encoded image by performing imaging, for example. For example, when a spectral image that is an acquisition target is x, x can be expressed by the following Expression 1.

$$\begin{matrix}[ Math . 1 ] & \\ x ∈ {ℝ}^{HW Λ} & ( Expression 1 )\end{matrix}$$

In Expression 1, H, W, and Λ indicate the number of elements of a vertical axis, a horizontal axis, and a spectral axis, respectively. The encoded image acquiring unit 10 may capture the spectral image which is the acquisition target as an encoded image y in a color or monochrome format through an optical system. In this case, y can be expressed by the following Expression 2.

$$\begin{matrix}[ Math . 2 ] & \\ y ∈ {ℝ}^{M} & ( Expression 2 )\end{matrix}$$

In Expressions 1 and 2, a relationship between signs is expressed as the following Expression 3.

$$\begin{matrix}[ Math . 3 ] & \\ N ( = HW Λ ) ≪ M & ( Expression 3 )\end{matrix}$$

A defect setting problem that occurs when the spectral image x is estimated from the encoded image y is referred to as a reconstruction problem. In addition, an optical observation process can be expressed as y=ϕx by using the following Expression 4.

$$\begin{matrix}[ Math . 4 ] & \\ Φ ∈ {ℝ}^{M \times N} & ( Expression 4 )\end{matrix}$$

The optical observation process that is a conversion from the spectral image x into the encoded image y may be any method of compressed spectral imaging. The encoded image may be captured at one timing on the time axis acquired by the encoded image acquiring unit 10, or encoded images may be acquired in time series discretely continuous on the time axis. In the following description, an example in which the encoded images are acquired in time series will be described.

The control unit 20 includes a processor such as a central processing unit (CPU) and a memory. The control unit 20 functions as a noise reducing unit 21 and an image reconstructing unit 22 when the processor executes programs. Moreover, all or some of the functions of the control unit 20 may be implemented by using hardware such as an application specific integrated circuit (ASIC), a programmable logic device (PLD), or a field programmable gate array (FPGA). The aforementioned programs may be recorded in a computer-readable recording medium. Examples of the computer-readable recording medium include a portable medium such as a flexible disk, a magneto-optical disc, a ROM, a CD-ROM, or a semiconductor storage device (e.g., solid state drive (SSD)), or a storage device such as a hard disk or a semiconductor storage device internally installed in a computer system. The aforementioned programs may be transmitted via a telecommunication line.

The noise reducing unit 21 executes a noise reducing process on encoded images acquired by the encoded image acquiring unit 10. The noise reducing unit 21 executes the noise reducing process on at least one encoded image of one or a plurality of encoded images y. In the following description, the noise reducing unit 21 executes the noise reducing process on at least one encoded image by using three time-series encoded images y_(i−1), y_i, and y_(i+1). Moreover, the number of encoded images used in the noise reducing process may be more than three or may be one or two. Details of a configuration of the noise reducing unit 21 and details of the noise reducing process will be described below. Moreover, the noise reducing unit 21 corresponds to a noise reducing device. In this case, the noise reducing device is configured as an information instrument (information processing device) including the above-described processor and the like.

The image reconstructing unit 22 reconstructs the spectral image on the basis of data of the encoded image in which noise has been reduced by the noise reducing unit 21. The image reconstructing unit 22 outputs data of the reconstructed spectral image.

The encoded image storage unit 30 is configured using a storage device such as a magnetic hard disk device or a semiconductor storage device. The encoded image storage unit 30 stores the data of the encoded image in which noise has been reduced by the noise reducing unit 21. By using the data stored in the encoded image storage unit 30, a spectral image in which noise has been reduced can be reconstructed.

### First Embodiment of Noise Reducing Unit

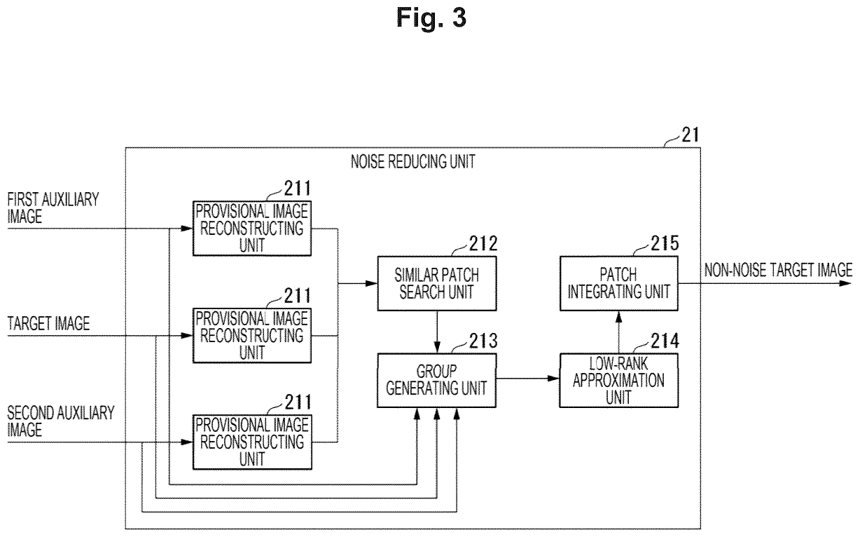

FIG. 3 is a diagram illustrating a first embodiment of the noise reducing unit 21. The noise reducing unit 21 includes one or a plurality of provisional image reconstructing units 211, a similar patch search unit 212, a group generating unit 213, a low-rank approximation unit 214, and a patch integrating unit 215. In the present embodiment, three time-series encoded images are input as described above. The three encoded images to be input are desirably close to each other in terms of time. For example, a certain encoded image (a target image in the following description), an encoded image generated at a timing immediately before the certain encoded image, and an encoded image generated at a timing immediately after the certain encoded image may be input.

In addition, in the present embodiment, noise is reduced for one encoded image, of the three encoded images to be input. For example, noise may be reduced for a middle encoded image in time series, of the three time-series encoded images to be input. In the following description, an encoded image to be in which noise has been reduced is referred to as a “target image”. Of the plurality of input encoded images, an encoded image other than the target image is referred to as an “auxiliary image”. In addition, when there are a plurality of auxiliary images, the auxiliary images are referred to as a “first auxiliary image” and a “second auxiliary image” in chronological order (in order from the earliest one) to be identifiable. Moreover, the noise reducing process is iteratively executed on a plurality of encoded images. An encoded image treated as the auxiliary image in a certain process is also treated as the target image in another process, so that noise is reduced. However, it is not always necessary to perform a noise reduction on all the encoded images, and for example, an encoded image in which noise has been reduced at a predetermined cycle may be obtained by treating the encoded image of the predetermined cycle as a target image.

The input three time-series encoded images are input to the provisional image reconstructing unit 211. The provisional image reconstructing unit 211 generates spectral images by performing reconstruction processing on the input encoded images (target image and auxiliary image). A method for reconstructing a spectral image executed in the provisional image reconstructing unit 211 may be any method as long as the method is a reconstruction technique of compressed sensing. In this case, for example, a value of ϕ in Expression 4 described above is required. The provisional image reconstructing unit 211 may have the value of ϕ in advance, or ϕ may be input to the provisional image reconstructing unit 211 together with the encoded image. Noise is not reduced in the spectral image generated by the provisional image reconstructing unit 211. The spectral image generated by the provisional image reconstructing unit 211 is referred to as a “provisional image”.

The similar patch search unit 212 divides the provisional image generated by each provisional image reconstructing unit 211 into a plurality of provisional patches. In this case, regions of the plurality of provisional patches may overlap each other in the same provisional image. The similar patch search unit 212 acquires another provisional patch having high similarity for each patch of the provisional image generated from the target image (hereinafter, referred to as “provisional target patch”). For example, for each provisional target patch, the similar patch search unit 212 evaluates the similarity by block matching with another provisional patch that satisfies a condition indicating spatially and temporally predetermined closeness, and collects the top K provisional patches. The value of K is a predetermined integer of 1 or larger. The similar patch search unit 212 outputs information (spatial information and temporal information) on positions of the collected top K provisional patches, as similar patch information. Moreover, a matching scale may be any one such as a mean square error.

The group generating unit 213 inputs the input encoded images (y_(i−1), y_i, and y_(i+1)) and the similar patch information and outputs similar patch group information Y_j. The group generating unit 213 obtains spatially and temporally corresponding patches in the encoded image on the basis of the position information in the provisional image of the similar patch information. Accordingly, the group generating unit 213 extracts similar encoded patches from the encoded image and outputs a similar patch group including these patches. For example, the extracted patches may be used as column vectors and may be stacked and arranged into a matrix to generate a similar patch group Y_j.

The low-rank approximation unit 214 receives the similar patch group Y_j as an input and generates Y\hat{ }_j obtained by performing low-ranking. The low-rank approximation unit 214 may use, for example, WNNM described in Patent Literature 1 described above or MC-WNNM that can effectively use redundancy between colors.

The low-rank approximation unit 214 first obtains a weight vector w. The weight vector w can be expressed as, for example, Expression 5 to be provided below.

$$\begin{matrix}[ Math . 5 ] & \\ {w}_{i} = c \sqrt{n} / ( \sqrt{max ( {σ}_{i}^{2} ( {Y}_{j} - n {σ}_{n}^{2} , 0 ) )} + ϵ ) & ( Expression 5 )\end{matrix}$$

Here, σ_i(Y_j) represents an i-th singular value of Y_j, c represents a constant of a positive real number, σ_n represents a noise variance, and ε represents a minute positive real number for avoiding division by zero. Next, the low-rank approximation unit 214 performs singular value decomposition on Y_j.

$$\begin{matrix}[ Math . 6 ] & \\ [ U , \sum , V ] = SVD ( {Y}_{j} ) & ( Expression 6 )\end{matrix}$$

Accordingly, the low-rank approximation unit 214 performs soft threshold processing using the weight vector w on the singular value to perform low-ranking.

$$\begin{matrix}[ Math . 7 ] & \\ {\hat{Y}}_{j} = U {𝒮}_{w} ( \sum ) {V}^{T} & ( Expression 7 )\end{matrix}$$

S_w(Σ) represents soft threshold processing using w as a threshold.

$$\begin{matrix}[ Math . 8 ] & \\ {𝒮}_{w} ( \sum ) = max ( \sum - w , 0 ) & ( Expression 8 )\end{matrix}$$

The patch integrating unit 215 generates an encoded image in which noise has been reduced by using the similar patch group Y\hat{ }_j in which noise has been reduced through low-rank approximation. The patch integrating unit 215 obtains spatial/temporal positions for patches (column vectors) of Y\hat{ }_j, before the patch division from the similar patch information, thereby integrating the divided patches to reconstruct the encoded image having the original size. Through such processing, the patch integrating unit 215 outputs data of a target image (hereinafter, referred to as a “non-noise target image”) in which noise has been reduced.

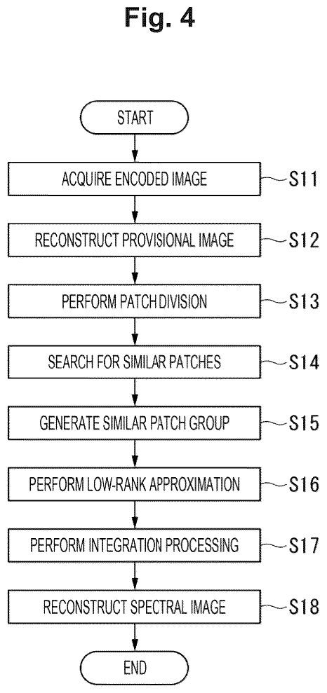

FIG. 4 is a flowchart illustrating a specific example of a processing flow of the spectral image generating device 100 including the noise reducing unit 21 of the first embodiment. First, the encoded image acquiring unit 10 acquires an encoded image used for the noise reducing process (Step S11). For example, as described above, in a case where three encoded images are used in the processing of the noise reducing unit 21 at a time, the encoded image acquiring unit 10 may acquire the three encoded images. The provisional image reconstructing unit 211 of the noise reducing unit 21 reconstructs provisional images for the input encoded images (Step S12).

The similar patch search unit 212 acquires a plurality of temporally and spatially spread provisional patches by performing patch division for the provisional images (Step S13). The similar patch search unit 212 searches for similar provisional patches that are provisional patches similar to each other (Step S14). For example, the similar patch search unit 212 may search for, as similar provisional patches, a predetermined number of provisional patches having high similarity for the provisional target patches to be processed. Through the processing, similar patch information is generated.

The group generating unit 213 obtains similar encoded patches spatially and temporally corresponding to each other in the encoded image on the basis of the similar patch information generated in the provisional images and generates a similar patch group (Step S15). The low-rank approximation unit 214 performs low-rank approximation on the generated similar patch group to generate a plurality of similar encoded patches in which noise has been reduced (Step S16). The patch integrating unit 215 generates an encoded image in which noise has been reduced, by integrating a plurality of similar encoded patches in which noise has been reduced, on the basis of spatial and temporal information. For example, the patch integrating unit 215 generates an encoded image (non-noise target image) in which noise has been reduced for the target image (Step S17). The image reconstructing unit 22 reconstructs the non-noise target image to generate a spectral image in which noise has been reduced (Step S18).

### Second Embodiment of Noise Reducing Unit

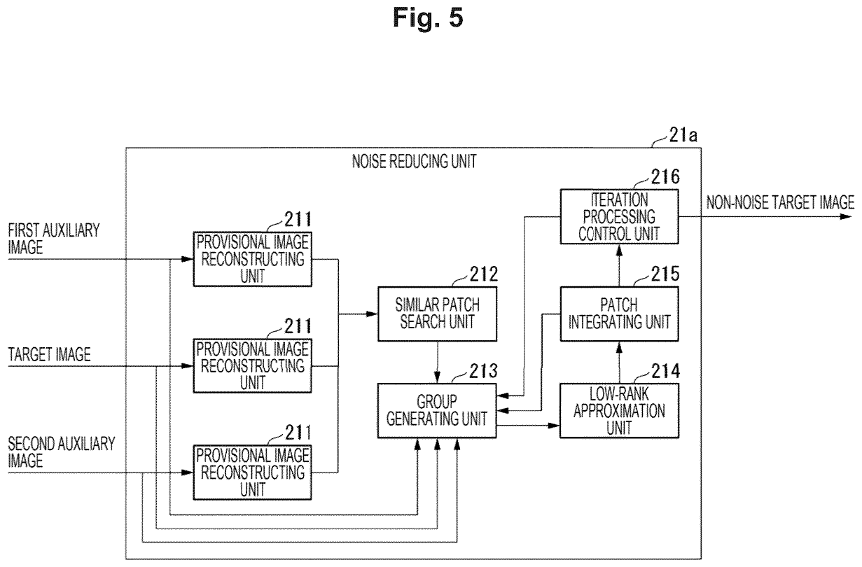

FIG. 5 is a diagram illustrating a second embodiment (noise reducing unit 21a) of the noise reducing unit 21. The noise reducing unit 21a of the second embodiment differs from the noise reducing unit 21 of the first embodiment in that an iteration processing control unit 216 is further provided. In addition, the group generating unit 213 of the first embodiment generates similar encoded patches in the input encoded images; however, the similar patch search unit 212 of the second embodiment generates similar encoded patches by using encoded images generated by the patch integrating unit 215 in iteration processing (processing after two cycles). Except for these differences, the noise reducing unit 21 of the first embodiment and the noise reducing unit 21a of the second embodiment have the same configuration. Therefore, the noise reducing unit 21a of the second embodiment may perform low-rank approximation not only for the input target image but also for the auxiliary image and integrate patches to generate an encoded image in which noise has been reduced. According to such a configuration, it is possible to more efficiently reduce noise in the iteration processing.

The iteration processing control unit 216 controls iteration processing in the group generating unit 213, the low-rank approximation unit 214, and the patch integrating unit 215, For example, the iteration processing control unit 216 determines and controls whether the processing in these functional units is further iterated or ended without iteration. The iteration processing control unit 216 may continue the iteration processing until a predetermined iteration end condition is satisfied (while not satisfied) and may end the iteration processing when the iteration end condition is satisfied. As a specific example of the iteration end condition, for example, a value indicating a predetermined number of iterations may be set, or a threshold may be set for a change amount in one step of the iteration processing.

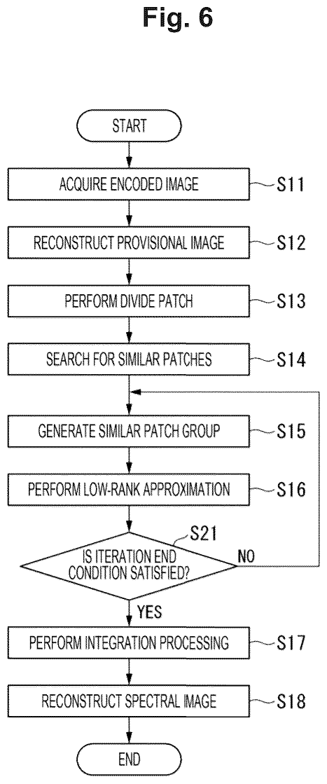

FIG. 6 is a flowchart illustrating a specific example of a processing flow of a spectral image generating device 100 including the noise reducing unit 21a of the second embodiment. In the process of FIG. 6, a branch process of Step S21 is provided after the process of Step S16 as compared with the process of FIG. 4. After the processes of Steps S11 to S16 are performed, the iteration processing control unit 216 determines whether or not the iteration end condition is satisfied (Step S21), In the case where the repetition end condition is not satisfied (NO in Step S21), the processes of Steps S15 to S21 are iteratively executed. On the other hand, in the case where the iteration end condition is satisfied (YES in Step S21), the processes of Steps S17 and S18 are executed.

The spectral image generating device 100 (including the first embodiment and the second embodiment) configured as described above searches for the spatial and temporal positions of the similar patches in the spectral image (provisional image) provisionally reconstructed from the encoded image. Depending on the result, corresponding patches are acquired in the encoded image, and the low-rank approximation is performed. Accordingly, a plurality of patches subjected to the low-rank approximation are integrated depending on spatial and temporal positions to construct an encoded image, and the encoded image in which noise has been reduced is generated. In this manner, since the spatial/temporal positions of the similar patches (similar provisional patches) are determined in the provisional images, the similar patches (similar encoded patches) can be searched for with higher accuracy. As a result, noise can be more accurately reduced in an encoded image obtained through the compressed spectral imaging. Specifically, when similar patches are searched for in the encoded image, grouping may be inaccurately performed due to the influence of ϕ. However, in the present embodiment, similar patches are searched for in the provisional images, so that more accurate grouping excluding the influence of ¢ can be performed.

In addition, with the above-described processing, it is possible to reduce noise of the encoded image without depending on the technique of compressed spectral imaging.

In addition, in the spectral image generating device 100 including the noise reducing unit 21a of the second embodiment, it is possible to generate an encoded image in which noise is further reduced by executing the iteration processing.

### Modification Examples

In the noise reducing unit 21 of the first embodiment, the noise reduction may be performed not only on the target image, of the plurality of input encoded images, but also on the plurality or all of the plurality of input encoded images.

In the noise reducing unit 21 of the second embodiment, the noise reduction may be performed on only some of the plurality of input encoded images instead of performing the noise reduction on all of the plurality of input encoded images.

In the noise reducing units 21 of the first embodiment and the second embodiment, only one encoded image may be input, or two or four or more encoded images may be input.

In the noise reducing units 21 of the first embodiment and the second embodiment, the number of the provisional image reconstructing units 211 does not absolutely need to be equal to the number of input encoded images (three in the aforementioned specific example). In a case where the number of the provisional image reconstructing units 211 is smaller than the number of input encoded images, one provisional image reconstructing unit 211 may perform reconstruction processing on a plurality of encoded images to generate a plurality of provisional images in one noise reduction.

As described above, the embodiments of the present invention have been described in detail with reference to the drawings; however, specific configurations are not limited to these embodiments and include designs or the like without departing from the gist of the present invention.

### INDUSTRIAL APPLICABILITY

The present invention is applicable to generation of a spectral image.

### REFERENCE SIGNS LIST

100 Spectral image generating device
10 Encoded image acquiring unit
20 Control unit
21 Noise reducing unit
211 Provisional image reconstructing unit
212 Similar patch search unit
213 Group generating unit
214 Low-rank approximation unit
215 Patch integrating unit
216 Iteration processing control unit
22 Image reconstructing unit
30 Encoded image storage unit
80 Encoded image
81 Similar encoded patch
90 Provisional image
91 Provisional patch
92 Similar provisional patch

1. A noise reducing device comprising:
a processor; and
a storage medium having computer program instructions stored thereon, when executed by the processor, perform to:
generates a provisional image by reconstructing an encoded image obtained through compressed spectral imaging;
acquires a plurality of similar provisional patches that are small regions including images similar to each other in the provisional image;
acquires a plurality of similar encoded patches that are small regions including images similar to each other in the encoded image based on information on positions where the similar provisional patches have been acquired;
performs low-rank approximation based on the plurality of similar encoded patches to acquire a patch in which noise on an image has been reduced in a region included in the similar encoded patches; and
generates an encoded image by integrating a plurality of patches in which noise has been reduced, depending on information on positions of the patches.

2. The noise reducing device according to claim 1, wherein the computer program instructions further perform to iteratively executes processes of at least the group generating unit and the low-rank approximation unit until a predetermined iteration end condition is satisfied.

3. The noise reducing device according to claim 1, wherein the computer program instructions further perform to generates the provisional image for each of a plurality of encoded images arranged in time series, and
the information on the positions includes information on a spatial position in an image and information on a temporal position in the time series.

4. A method for reducing noise, comprising:
a provisional image reconstructing step of generating a provisional image by reconstructing an encoded image obtained through compressed spectral imaging;
a similar patch searching step of acquiring a plurality of similar provisional patches that are small regions including images similar to each other in the provisional image;
a group generating step of acquiring a plurality of similar encoded patches that are small regions including images similar to each other in the encoded image based on information on positions where the similar provisional patches have been acquired;
a low-rank approximation step of performing low-rank approximation based on the plurality of similar encoded patches to acquire a patch in which noise on an image has been reduced in a region included in the similar encoded patches; and
a patch integrating step of generating an encoded image by integrating a plurality of patches in which noise has been reduced, depending on information on positions of the patches.

5. A computer program for causing a computer to function as the noise reducing device according to claim 1.
